(19) United States
(12) Patent Application Publication
(10) Pub. No.: US 2026/0116513 A1
(43) Pub. Date: Apr. 30, 2026

(54) Floating Wind Turbine with Floats Providing Reduced Fluid Resistance

(71) Applicant: Vincent Loccisano, Wellesley, MA (US)

(72) Inventor: Vincent Loccisano, Wellesley, MA (US)

(21) Appl. No.: 18/925,227

(22) Filed: Oct. 24, 2024

(51) Int. Cl. B63B 39/03; B63B 35/44; F03D 13/25

(52) U.S. Cl. CPC B63B 39/03; B63B 35/44; F03D 13/256; B63B 2035/446; F05B 2240/93; F05B 2240/95

(57) ABSTRACT

A floating wind turbine is supported by floats that are made up of a bow form having a bulbous form protrusion and a lower cylindrical portion. Ballast is controlled to move the water line below the bow during operation and above the bow and bulbous form during towing.

### TECHNICAL FIELD

The present disclosure relates in general to wind turbines and more specifically to shallow floats supporting offshore wind turbines and increasing the speed of towing at sea.

### BACKGROUND OF THE INVENTION

A wind turbine is a rotating machine that converts kinetic energy from wind into mechanical energy that is converted to electricity. Utility-scale, horizontal-axis wind turbines have horizontal shafts that drive a generator assembly within a tower-top nacelle, that is yawed relative to the tower to align the rotor with the wind. Either a transmission and generator combination or a larger direct drive generator are commonly used.

The state of the art includes offshore wind turbines that rest on the ocean bottom and are neither designed nor intended to be moved. In waters shallower than 60 m, wind turbines used for offshore applications commonly include single-tower systems mounted to the seabed. In deeper waters the turbines must float, using spar-buoy or semi-submersible platforms, tension legs, or a large-area barge-type construction. Offshore turbines are usually connected to an onshore power grid and electrical energy produced is transferred by ocean-floor grid structures.

The hull shape of a leg-supporting float is commonly dependent on considerations such as strength, weight, displacement, wave motion, and behavior when towed. Hull shapes range from a square end, in the case of a scow barge, to the pointed surface of a sailboat racing hull, to the cylindrical shape of a harbor buoy.

A bulbous form, a protruding structure located at the forefoot of a vessel, has been employed for centuries to improve hydrodynamic efficiency. The bulbous form primarily serves to reduce wave resistance. By generating a wave system that interferes constructively with the vessel's main wave system, the bulbous form can effectively reduce the overall wave-making resistance, leading to improved fuel efficiency and increased speed when moving through the water.

There is widespread recognition among professionals in the wind industry that installation, maintenance and repair conducted offshore is far more expensive and time consuming than similar tasks conducted on land or in a near-land facility.

### SUMMARY OF THE INVENTION

In accordance with example embodiments of the present disclosure, an apparatus for generating offshore wind energy employs shallow draft floats supporting a lattice tower with a wide base having a single-line anchoring providing passive yawing.

A floating structure for towably supporting an offshore wind turbine uses floats of various configurations. The structure enables launching of an offshore wind turbine in a shallow port, and towing to a mooring. The structure is designed in varying iterations to allow for increased speed during towing and stability when moored.

In an example embodiment a lattice structure has four legs each connected to a shallow float at the base. Each leg is joined at the top to a horizontal structure that is configured to support a wind turbine rotor. The base of at least two of the lattice structure legs are connected to a V-shaped structure that is a mooring and towing point. The overall structure is an irregular pentagon with four vertices in a rectangular pattern and a fifth vertex extending from the mid-point of two of the other vertices. The fifth vertex is configured with equipment appropriate to function as a mooring or towing point, also referred to as a hitch point. One skilled in the art is familiar with mooring points, towing apparatus, fifth wheels and the like as are used in towing and mooring. Mooring from a single point on the turbine lattice structure in combination with shallow floats allows the turbine to passively yaw into the wind and eliminates the need for a mechanical yaw system in a nacelle. Shallow floats in combination with a wide base and a single towing point allow for the turbine to be erected on or near land to avoid the need for an ocean based crane.

In an example embodiment a turbine may be switched with one requiring maintenance or repair. In such a case, a tugged turbine is swapped with a moored turbine. A relatively small tug boat may be adapted to clasp the hitch point on a turbine to maneuver it to a mooring and again to clasp the hitch point of a turbine to be removed to tow it to a land based location.

A shallow draft float is designed to support the lattice structure legs. Shallow draft floats provide a low cost solution that facilitates towing. In order to overcome the typical distance between shore and an offshore wind field, a towing speed close to 10-knots is necessary. A bulbous form is a protruding bulb at the bow of a hull that resides below the waterline. The bulbous form serves to reduce wave resistance by generating a wave system that interferes constructively with the vessel's main wave system. The resultant shallow draft float with a bulbous form reduces the overall wave-making resistance of each float on the turbine structure, leading to improved fuel efficiency and increased speed when towing the structure to shore for maintenance or from shore to swap with a turbine in need of maintenance. When not being towed, a ballast system reduces ballast to raise the bulbous form out of the water. The same ballast system lowers the bulbous form beneath the water when towing.

### BRIEF DESCRIPTION OF DRAWINGS

FIG. 1 is a perspective view of an example floating turbine with shallow floats:

FIG. 2 is a perspective view of a float of the present disclosure;

FIG. 3 is a section view of a float of the present disclosure;

FIG. 4 is a perspective view of an iteration of the embodiment;

FIG. 5 is a diagram of a method of the embodiment.

### DETAILED DESCRIPTION

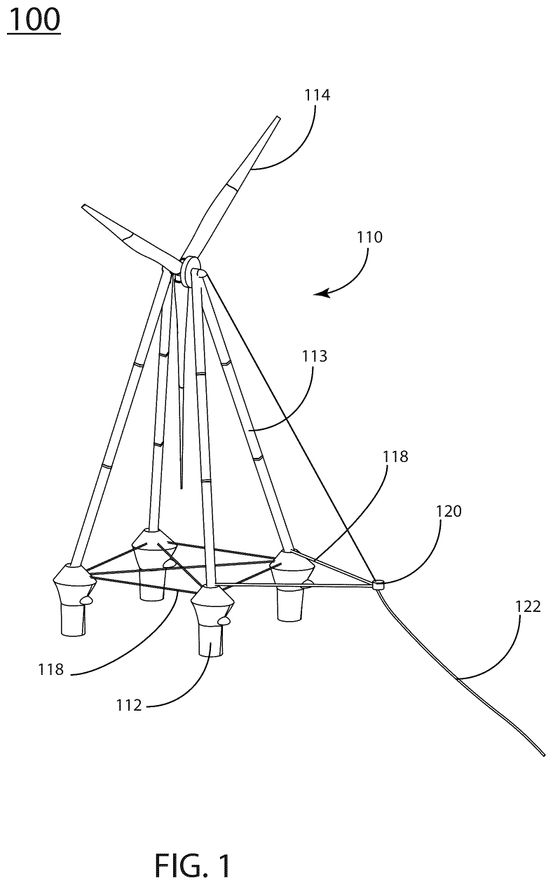

Referring to FIG. 1 a perspective view of an example floating wind turbine 110 is depicted in the illustration. A rotor 114 is supported by structural elements 113 that are in turn supported by floats 112 that are further braced or moored by a lower structure 118. The lower structure is joined with a hitch point 120 that is joined to a mooring line 122.

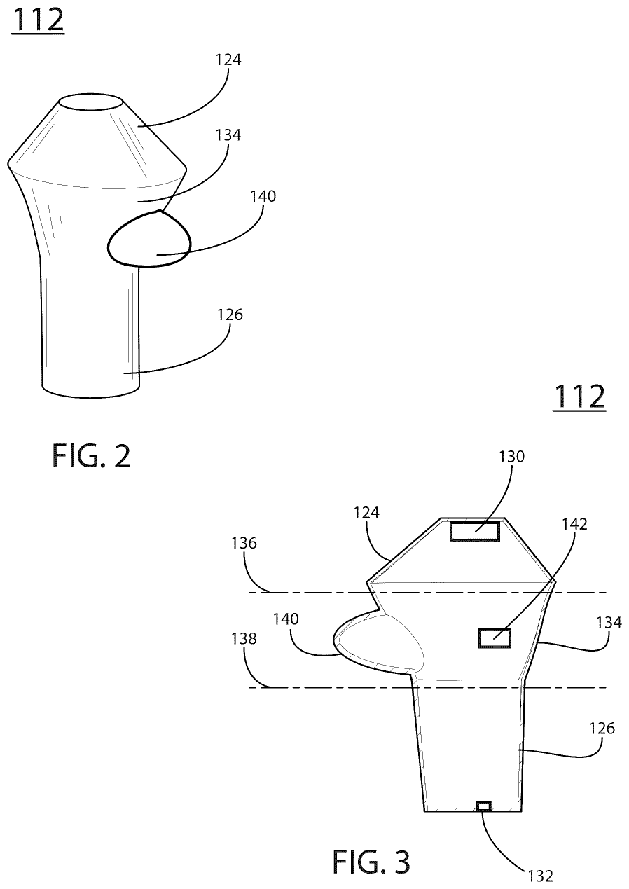

Referring to FIG. 2 and FIG. 3 in one embodiment the floats 112 are made up of a cylindrical lower portion 126 and a hull shaped portion 134 which is capped by a conical section 124. A bulbous form 140 is formed in the bow 134. In the example embodiment 112, a pump 130 and valve 132 control the amount of water ballast and air pressure inside the float 112. In some embodiments, the pump 130 and valve 132 on each of the floats 112 (FIG. 1) coupled with one or more sensors 142, configured to measure water level of each float 112, are electronically coupled to a control unit. The control unit receives signals from the sensor(s) 142 to move ballast in through the pump 130 or out through the valve 132 to maintain the float 112 at a predetermined relation to the water level and so to maintain the turbine 110 in a substantially level orientation. In this example, as one float rises out of the water ballast is increased and as another float sinks past a threshold water level, ballast is removed.

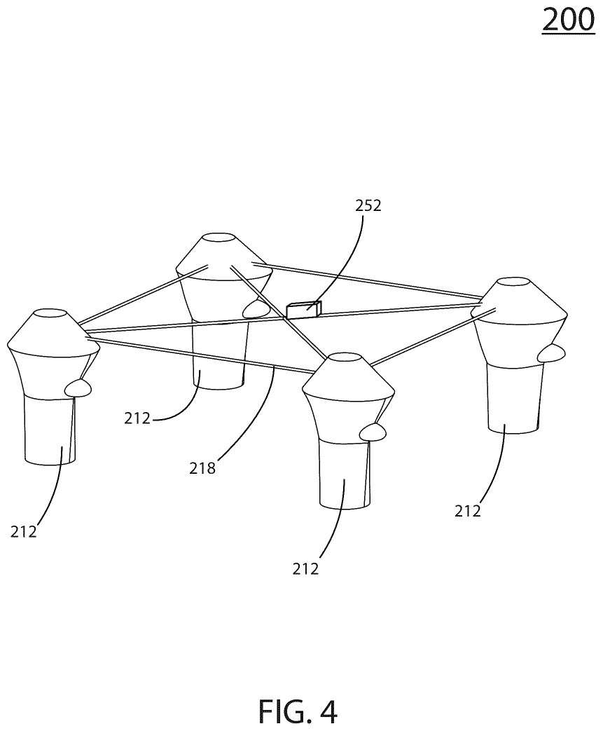

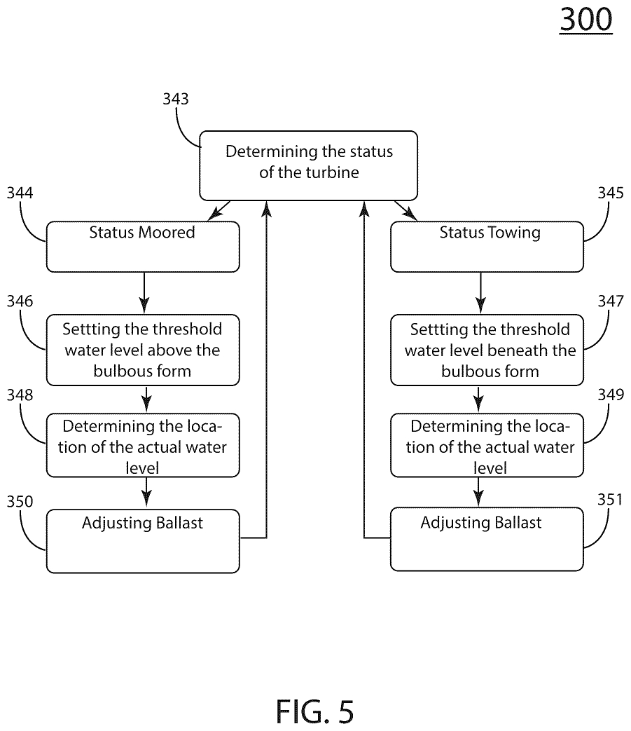

FIG. 4 is a diagram of a method of operating the apparatus of FIG. 1-FIG. 3. When the turbine is moored and operating the ballast and air are controlled to maintain the water line, represented by line 138 (FIG. 3), beneath the bulbous form 140 (FIG. 3). When the turbine is towed into or away from shore, ballast is pumped into the floats to maintain the water line, represented by line 136 (FIG. 3), above the bulbous form w form 140 (FIG. 3). When the bulbous form 140 (FIG. 3) is just beneath the water line the form moves more easily through the water for faster towing.

A method 200 begins by determining the status of the turbine 243. If the status is determined as moored 244 the process continues by setting the threshold water level to an area above the bulbous form 246. The process continues by determining the location of the actual water level 248, and follows by adjusting the ballast 250 so that the actual water level 248 remains proximal to the threshold water level 246, wherein the process repeats. One skilled in the art understands that the water level may vary but the actual water level will be reflected in the threshold water level as an average over time of the actual water level. Upon determining the status of the turbine 243, the turbine is being towed 245, the process continues by setting the threshold water level to an area beneath the bulbous form 247. The process continues by determining the location of the actual water level 249, and follows by adjusting the ballast 251 so that the actual water level 249 remains proximal to the threshold water level 247, wherein the process repeats.

1. A shallow draft float comprising:
a cylindrical lower portion; fixedly engaged with a hull shaped portion; and
said hull shaped portion having a bow and stern, capped by a conical portion; and
a bulbous form fixedly engaged with the bow of the hull shaped portion.

2. The apparatus of claim 1 further comprising:
a pump fluidly coupled with the apparatus; and
a valve fluidly coupled with the apparatus; and
at least one sensor engaged with the apparatus, configured to sense the water level with respect to the apparatus; and
the pump and valve electronically controlled by a controller; wherein
signals from the at least one sensor determine location of the apparatus in relation to a threshold water level, and are received in the controller wherein the pump and valve are controlled to alter ballast to maintain the water level within the threshold.

3. The apparatus of claim 2 wherein:
when the apparatus is in a moored capacity the threshold is maintained beneath the bulbous form.

4. The apparatus of claim 2 wherein:
when the apparatus is moving, the threshold is maintained above the bulbous form.

5. A method for operating the apparatus of claim 2 when moored, the method comprising:
determining the status of the apparatus as moored; and
setting the threshold water level in the controller, above the bulbous form; and
determining the location of the actual water level with respect to the threshold water level; and
adjusting ballast until the actual water level is near the threshold water level.

6. A method for operating the apparatus of claim 2 when being towed, the method comprising:
determining the status of the apparatus as being towed; and
setting the threshold water level in the controller, beneath the bulbous form; and
determining the location of the actual water level with respect to the threshold water level; and
adjusting ballast until the actual water level is near the threshold water level.
